(19) United States
(12) Patent Application Publication
(10) Pub. No.: US 2011/0316838 A1
(43) Pub. Date: Dec. 29, 2011

(54) APPARATUS FOR SUPPLYING POWER, DISPLAY DEVICE HAVING THE SAME, AND DRIVING METHOD THEREOF

(76) Inventor: Jung-Keun AHN, Yongin-city (KR)

(21) Appl. No.: 13/092,089

(22) Filed: Apr. 21, 2011

(30) Foreign Application Priority Data
Jun. 29, 2010 (KR) 10-2010-0062269

(51) Int. Cl. G06F 3/038

(52) U.S. Cl. 345/211

(57) ABSTRACT

An apparatus for supplying a power source voltage, a display device having the same, and a driving method thereof, includes: a DC-DC converter for generating a power source voltage corresponding to an input voltage and a feedback voltage, and for supplying the power source voltage to a display region comprising a plurality of light emitting elements; and a power source voltage controller for detecting an input current flowing to the DC-DC converter and the power source voltage outputted from the DC-DC converter, for generating the feedback voltage corresponding to the input current and the power source voltage, and for supplying the feedback voltage to the DC-DC converter.

### CROSS-REFERENCE TO RELATED APPLICATION

This application claims priority to and the benefit of Korean Patent Application No. 10-2010-0062269 filed in the Korean Intellectual Property Office on Jun. 29, 2010, the entire contents of which are incorporated herein by reference.

### BACKGROUND

1. Field

Embodiments according to the present invention relate to an apparatus for supplying power, a display device having the same, and a driving method thereof, and more particularly, as relates to an organic light emitting diode (OLED) display.

2. Description of Related Art

In a display device, a plurality of pixels are arranged in a matrix form on a substrate to be used as a display area, scan lines and data lines are connected to the pixels, and data signals are selectively applied to the pixels to display an image.

Currently, display devices are classified as either a passive matrix type of light emitting display device or an active matrix type of light emitting display device, depending on how the pixels are driven. Among them, the active matrix type of light emitting display device, in which unit pixels are selectively turned on, is becoming more popular due to its resolution, contrast, and operation speed.

These display devices are used as display devices of mobile information terminals such as personal computers, mobile phones, personal digital assistants (PDAs), and the like, or as monitors for various information devices. Types of display devices include a liquid crystal display (LCD) using a liquid crystal panel, an organic light emitting diode (OLED) display device using an organic light emitting element, and a plasma display panel (PDP), among others. These and various other light emitting display devices that are lighter and smaller when compared to cathode ray tubes (CRTs) have been under development, and in particular, OLED display devices having excellent luminous efficiency, excellent luminance, a wide viewing angle, and fast response times, have received much attention.

In the case of OLED display devices, gray levels are represented by controlling current flowing across an OLED, and a driving transistor is used to control current supplied to the OLED. An operation region of the driving transistor is divided into a saturation region and a linear region. In general, a source electrode of the driving transistor is fixed at a certain power source voltage, and a data voltage inputted to a gate electrode is changed according to a gray level.

Thus, in order for the driving transistor to control current supplied to the OLED according to a data voltage, the driving transistor must operate in the saturation region. If the driving transistor operates in the linear region, current flowing across the driving transistor would be changed according to a drain-source voltage, so that even when the same data voltage is applied, a different current may be supplied to the OLED according to the driving transistor. In order for the driving transistor to operate in the saturation region, the drain-source voltage of the driving transistor must have a higher level than that of a certain saturation voltage.

The driving voltage of the OLED changes according to the temperature of the display device or due to degradation of the OLED resulting from prolonged use of the display device with the passage of time.

As the use time of the display device increases, a driving voltage generally needs to be increased to apply a same current, due to gradual degradation of the OLED itself. In addition, the driving voltage varies according to a change in temperature, such as variations between a low temperature, room temperature, and a high temperature.

In the related art OLED display, power source voltages are set to have a sufficient margin so that even when the driving voltage of the OLED is changed, the drain-source voltage level of the driving transistor is greater than the saturation voltage level. Power voltages refer to voltages supplied to high and low ends when the driving transistor and the OLED are connected in series.

However, securing a voltage margin for stably driving the OLED may unnecessarily increase power consumption.

The above information disclosed in the Background section is only for enhancement of understanding of the background of the invention, and therefore may contain information that does not form the prior art that is already known in this country to a person of ordinary skill in the art.

### SUMMARY OF THE INVENTION

Embodiments of the present invention provide a display device that can detect display panel characteristics while the display device is being driven, and search for optimum driving conditions, to prevent or reduce occurrence of a driving voltage of an organic light emitting diode (OLED) being degraded due to, for example, prolonged use of the display device with the passage of time and fluctuations in temperature, causing picture quality characteristics to be lowered.

Embodiments of the present invention also provide an apparatus for supplying power and reducing power consumption while securing a sufficient voltage margin, to maintain picture quality characteristics by periodically or arbitrarily detecting or monitoring characteristics or properties of a display panel of a display device being driven.

Embodiments of the present invention also provide a method for driving a display device for implementing a higher quality screen image by searching for an optimum driving voltage that minimizes or reduces power consumption to drive a display device with a corresponding driving voltage, and readjusting the driving voltage in response to degradation of organic light emitting diodes (OLEDs) resulting from prolonged use of the display device with the passage of time, and providing the readjusted driving voltage.

An exemplary embodiment of the present invention provides an apparatus for supplying a power source voltage, including: a DC-DC converter for generating a power source voltage corresponding to an input voltage and a feedback voltage, and for supplying the power source voltage to a display region comprising a plurality of light emitting elements; and a power source voltage controller for detecting an input current flowing to the DC-DC converter and the power source voltage outputted from the DC-DC converter, for generating the feedback voltage corresponding to the input current and the power source voltage, and for supplying the feedback voltage to the DC-DC converter.

The DC/DC converter may be configured to receive the input voltage through an input line, and to deliver the power source voltage to each of the light emitting elements through a power line.

The input current may be detected by utilizing a detection resistor at the input line.

The power source voltage controller may include: a logic unit for detecting a saturation voltage value corresponding to a saturation point in a driving voltage range for driving the display region by utilizing variations in output voltage data corresponding to the power source voltage and in input current data corresponding to the input current, and for generating reference voltage data or a plurality of control signals for controlling the feedback voltage so that the power source voltage is adjusted to be a voltage corresponding to the saturation voltage value; and a feedback voltage generating unit for generating the feedback voltage according to the reference voltage data or the plurality of control signals.

The power source voltage controller may further include an amplifying unit for amplifying a voltage difference between the ends of the detection resistor, and for outputting the amplified voltage difference.

The power source voltage controller may further include an analog-to-digital converter for generating the input current data from a detection voltage according to a voltage difference between the ends of the detection resistor, and for outputting the input current data to the logic unit. The detection voltage may be a voltage that has been amplified by an amplifying unit.

The power source voltage controller may further include an analog-to-digital converter for generating the output voltage data corresponding to the power source voltage detected from a power line for delivering the power source voltage to the display region, and for outputting the generated output voltage data to the logic unit.

The feedback voltage generating unit may include a first resistor unit and a second resistor unit connected in series between a power line for delivering the power source voltage to the plurality of light emitting elements and a reference voltage supplying unit for supplying a reference voltage. The feedback voltage generating unit may be configured to generate the feedback voltage by voltage dividing a voltage difference between the power source voltage and the reference voltage.

The feedback voltage may be determined according to a resistance ratio of the first and second resistor units.

The reference voltage supplying unit may include a digital-to-analog converter for generating the reference voltage according to the reference voltage data generated by the logic unit.

The reference voltage supplying unit may include an output terminal of the DC-DC converter supplying the power source voltage.

The reference voltage supplying unit may further include a buffer between the digital-to-analog converter and the first and second resistor units.

The second resistor unit of the feedback voltage generating unit may include a plurality of resistors connected in series between the first resistor unit and the reference voltage supplying unit; and a plurality of switching elements respectively connected in parallel to the ends of corresponding ones of the resistors for performing a switching operation according to corresponding control signals from among a plurality of control signals that adjust a feedback voltage.

Another embodiment of the present invention provides a display device including: a display region including a plurality of light emitting elements configured to receive a first power source voltage and a second power source voltage having a lower voltage than the first power source voltage; a DC-DC converter for generating the second power source voltage corresponding to an input voltage and a feedback voltage, and for supplying the second power source voltage to the plurality of light emitting elements; and a power source voltage controller for detecting an input current flowing to the DC-DC converter and the second power source voltage outputted from the DC-DC converter, for generating the feedback voltage corresponding to the input current and the second power source voltage, and for supplying the feedback voltage to the DC-DC converter.

Yet another embodiment of the present invention provides a method for driving a display device, including: detecting an input current flowing to a DC-DC converter that generates a power source voltage and supplies the power source voltage to light emitting elements in a display region; detecting the power source voltage outputted from the DC-DC converter; generating a feedback voltage adjusted corresponding to the input current and the power source voltage; and adjusting the power source voltage according to the feedback voltage and supplying the adjusted power source voltage to the light emitting elements.

The detecting of the input current may include: measuring a voltage difference between the ends of a detection resistor at an input line that delivers the input current to the DC-DC converter; amplifying the measured voltage difference; and generating and supplying input current data corresponding to the amplified voltage difference.

The detecting of the power source voltage may include: measuring the power source voltage from a power line that delivers the power source voltage from the DC-DC converter; and generating and supplying output voltage data corresponding to the power source voltage.

The generating of the feedback voltage may include: detecting a saturation voltage value corresponding to a saturation point in a driving voltage range for driving the display region by utilizing variations in output voltage data corresponding to the detected power source voltage and in the input current data corresponding to the detected input current; generating reference voltage data or a plurality of control signals for controlling the feedback voltage so that the power source voltage is adjusted to be a voltage corresponding to the saturation voltage value; and generating the feedback voltage according to the reference voltage data or the plurality of control signals.

The generating of the feedback voltage may further include: generating a reference voltage according to the reference voltage data; and voltage-dividing a voltage difference between the power source voltage and the reference voltage.

In the generating of the feedback voltage, the voltage difference between the power source voltage and the reference voltage may be voltage-divided according to a resistance ratio between first and second resistor units connected in series, wherein the resistance ratio may be adjusted by selectively connecting a plurality of resistors in the second resistor unit according to the plurality of control signals.

According to an exemplary embodiment of the present invention, because display panel characteristics of a display device being driven are detected, and a power source voltage according to optimum driving conditions is provided, degradation of the OLED resulting from prolonged use of the display device with the passage of time and/or temperature fluctuations can be compensated for, and thus, higher picture quality can be maintained.

According to an exemplary embodiment of the present invention, because the apparatus for supplying power periodically or arbitrarily detects the characteristics of a display panel of a display device being driven, and provides a power source voltage according to optimum driving conditions, a sufficient voltage margin for maintaining picture quality can be secured without wasting power.

In addition, when a method for searching for an optimum driving voltage minimizing or reducing power consumption is utilized, the driving voltage can be readjusted to compensate for degradation of OLEDs resulting from prolonged use of the display device with the passage of time. Thus, the display device can more stably maintain screen quality.

### BRIEF DESCRIPTION OF THE DRAWINGS

FIG. 1 is a schematic block diagram of a display device according to an exemplary embodiment of the present invention;

FIG. 2 is an equivalent circuit diagram of a pixel (PX) illustrated in FIG. 1;

FIG. 3 is a graph showing a voltage-current characteristic curve of a display unit 10 illustrated in FIG. 1;

FIG. 4 is a schematic block diagram showing an apparatus for supplying power according to an exemplary embodiment of the present invention; and

FIG. 5 is a schematic block diagram showing an apparatus for supplying power according to another exemplary embodiment of the present invention.

### DESCRIPTION OF SELECTED REFERENCE NUMBERS

| | |
|---|---|
| 10: display region | 20: scan driver |
| 30: data driver | 40: controller |
| 50, 70: DC-DC converter | 60, 80: power source |
| | voltage controller |
| 601,801: amplifying unit | |
| 602, 606, 802, 806: analog-to-digital | |
| converter | |
| 603, 803: logic unit | 604, 804: storage unit |
| 605: digital-to-analog converter | |
| 607, 805: feedback voltage generating unit | |

### DETAILED DESCRIPTION OF THE EMBODIMENTS

The present invention will be described more fully hereinafter with reference to the accompanying drawings, in which exemplary embodiments of the invention are shown. As those skilled in the art will recognize, the described embodiments may be modified in various different ways without departing from the spirit or scope of the present invention.

In the various exemplary embodiments, the same or similar reference numerals are used for elements having the same or similar configurations and will be representatively described in a first exemplary embodiment. In other exemplary embodiments, only elements different from those in the first exemplary embodiment will be described in detail.

Throughout this specification and the claims that follow, when it is described that an element is “coupled” to another element, the element may be “directly coupled” to the other element, or “electrically coupled” to the other element, either directly or indirectly through one or more intervening elements.

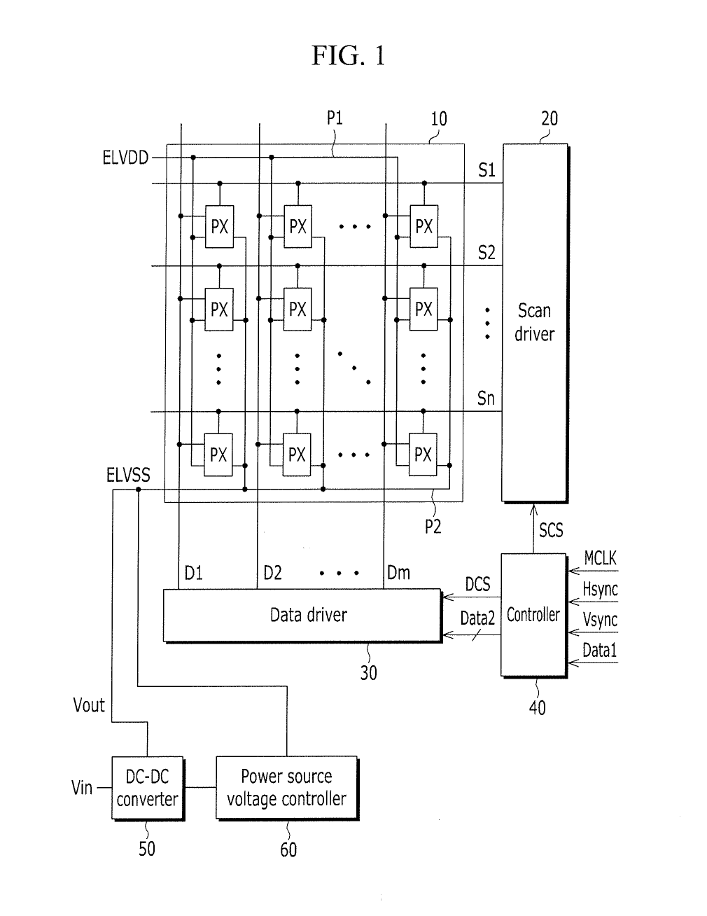

FIG. 1 is a schematic block diagram of a display device according to an exemplary embodiment of the present invention.

The display device according to an exemplary embodiment of the present invention of FIG. 1 includes a display region 10, a scan driver 20, a data driver 30, a controller 40, a DC-DC converter 50, and a power source voltage controller 60.

The display region 10 displays images by receiving a first power source voltage ELVDD and a second power source voltage ELVSS, and receiving a plurality of scan signals and a plurality of data signals from the scan driver 20 and the data driver 30, respectively.

With reference to FIG. 1, the display region 10 includes a plurality of pixels PX that are connected to a plurality of signal lines S1˜Sn and D1˜Dm and to first and second power lines P1 and P2, and that are substantially arranged in a matrix form.

Here, the plurality of signal lines S1˜Sn and D1˜Dm include a plurality of scan lines S1˜Sn on which a plurality of scan signals are sequentially transferred, and a plurality of data lines D1˜Dm on which a plurality of data signals are transferred. The plurality of scan lines S1˜Sn extend substantially in a row (e.g., horizontal) direction and are substantially parallel to each other, and the plurality of data lines D1˜Dm extend substantially in a column (e.g., vertical) direction and are substantially parallel to each other.

A first power source voltage ELVDD is supplied to each of the plurality of pixels included in the display region 10 through the first power line P1. The first power source voltage ELVDD may be applied as a fixed voltage value by an apparatus for supplying power.

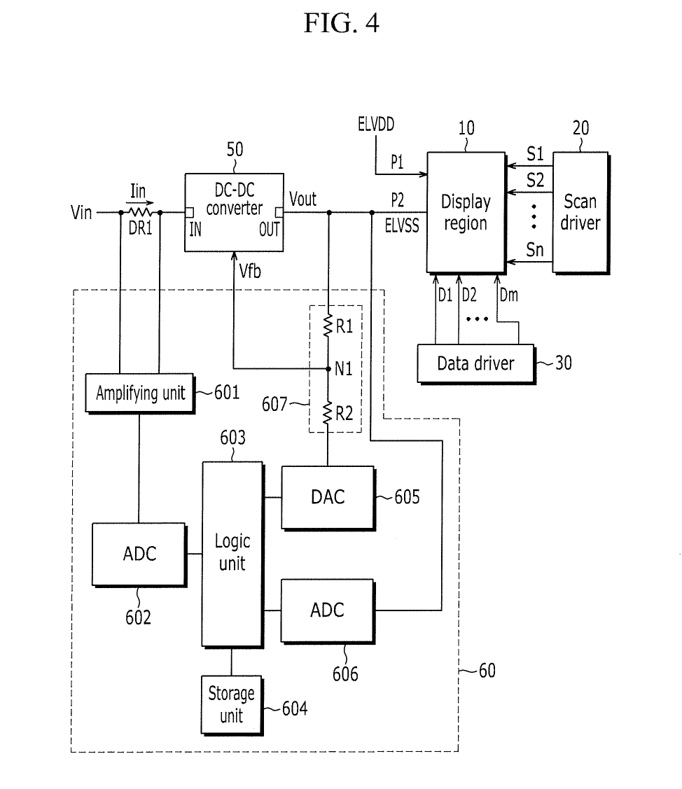

Also, a second power source voltage ELVSS is supplied to each of the plurality of pixels included in the display region 10 through the second power line P2. The second power line P2 connects an output terminal OUT (see, e.g., FIG. 4) of the DC-DC converter 50 and the display region 10.

As shown in FIG. 1, the first power line P1 extends to each of the plurality of pixels PX to supply the first power source voltage ELVDD having a fixed voltage value to each of the plurality of pixels PX. The second power line P2 extends to each of the plurality of pixels PX to supply the second power source voltage ELVSS, outputted through the output terminal of the DC-DC converter 50, to each of the plurality of pixels PX. In detail, the second power line P2 is connected to a cathode electrode of each of the plurality of pixels PX, such that a current corresponding to the sum of all of the currents flowing across the plurality of pixels PX of the display region 10 flows through the second power line P2.

The controller 40 controls a video signal Data1 from the exterior to generate a data video signal Data2 that can be displayed as an image on the display region 10, and delivers the generated data video signal Data2 to the data driver 30. In addition, the controller 40 generates driving control signals for controlling driving of the scan driver 20 and the data driver 30 by using a horizontal synchronization signal Hsync, a vertical synchronization signal Vsync, and a clock signal MCLK from the exterior. A data driving control signal DCS generated by the controller 40 is supplied to the data driver 30, and a scan driving control signal SCS is supplied to the scan driver 20.

In the present exemplary embodiment illustrated in FIG. 1, the power source voltage controller 60 is separately provided, but in another exemplary embodiment, the power source voltage controller 60 may be included in the controller 40.

An apparatus for supplying power according to the exemplary embodiment of the present invention illustrated in FIG. 1 detects characteristics of the display region 10 by using the second power source voltage ELVSS and controls the second power source voltage ELVSS such that it conforms to optimum or more efficient driving conditions. The apparatus for supplying power includes the DC-DC converter 50 and the power source voltage controller 60.

The DC-DC converter 50 and the power source voltage controller 60 are connected to the second power line P2 that is connected to each of the plurality of pixels of the display region 10.

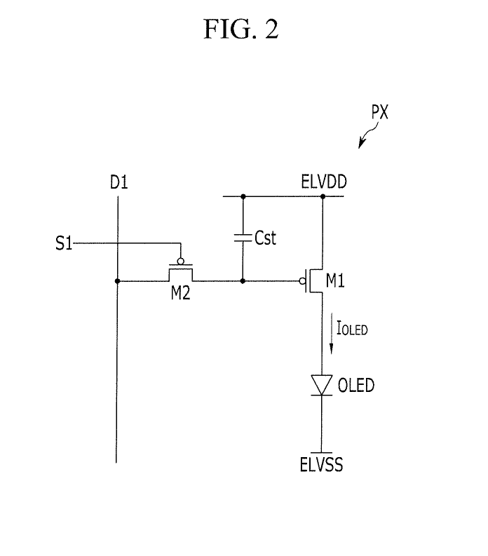

FIG. 2 is an equivalent circuit diagram of a pixel (PX) illustrated in FIG. 1.

With reference to FIG. 2, a pixel PX connected to the scan line S1 and the data line D1 in the embodiment illustrated in FIG. 1 includes an organic light emitting element (i.e., an organic light emitting diode (OLED)), a driving transistor M1, a capacitor Cst, and a switching transistor M2. In a different exemplary embodiment, each pixel PX may further include a light emission control transistor M3 positioned between the driving transistor M1 and the OLED for controlling light emission of the OLED. The elements of each pixel PX are not limited to those illustrated in FIG. 2, and each pixel PX may be configured with various elements and/or arrangements.

In FIG. 2, the driving transistor M1 has a source electrode receiving the first power source voltage ELVDD, a drain electrode connected to an anode electrode of the OLED, and a gate electrode connected to a drain electrode of the switching transistor M2.

The driving transistor M1 applies current I_{OLED}, whose magnitude varies depending on an operation voltage Vgd applied between the gate electrode and drain electrode of driving transistor M1, to the OLED. Then, the OLED correspondingly emits light according to the magnitude of the current I_{OLED}.

The switching transistor M2 has a gate electrode connected to the scan line S1, a source electrode connected to the data line D1, and a drain electrode connected to the gate electrode of the driving transistor M1. The switching transistor M2 performs a switching operation in response to a scan signal applied to its gate electrode through the scan line S1. When the switching transistor M2 is turned on by the scan signal, a data signal, that is, a data voltage corresponding to the data signal, transferred through the data line D1, is transferred to the gate terminal of the driving transistor M1.

The capacitor Cst includes one electrode connected to the first power source voltage EVLDD to which the source electrode of the driving transistor M1 is connected, and another electrode connected to the gate electrode of the driving transistor M1. The capacitor Cst charges the data voltage applied to the gate electrode of the driving transistor M1 during a certain time. The capacitor Cst maintains the charged data voltage after the switching transistor M2 is turned off.

The OLED receives the second power source voltage ELVSS at its cathode electrode. The OLED emits light of varying strength depending on the current I_{OLED} supplied by the driving transistor M1.

As described above, in a different exemplary embodiment, a light emission control transistor M3 (not shown) for controlling transmission of the driving current I_{OLED} supplied to the cathode electrode of the OLED may be further provided, to control the light emission of the OLED of each pixel.

Meanwhile, in FIG. 2, the driving transistor M1 and the switching transistor M2 are configured as PMOS transistors, but the present invention is not limited thereto, and at least one of the driving transistor M1 or the switching transistor M2 may be configured as an NMOS transistor.

In addition, the connection relationships among the driving transistor M1, the switching transistor M2, the capacitor Cst, and the OLED may be modified. The pixel PX illustrated in FIG. 2 is an example of a pixel of the display device, and different pixels including, for example, at least two transistors or at least one capacitor may also be used.

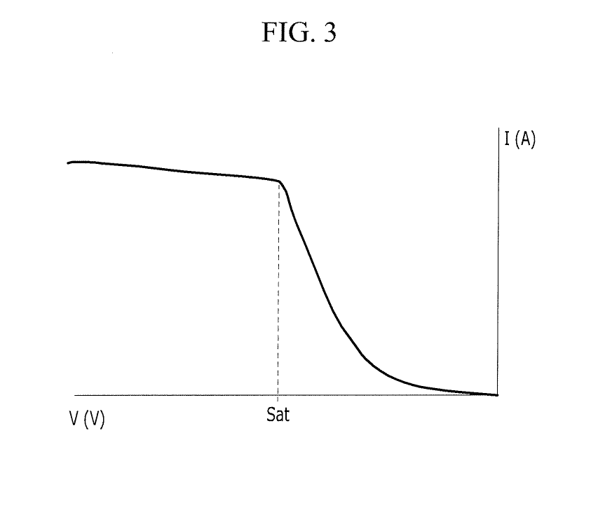

FIG. 3 is a graph showing a voltage-current characteristic curve of the display region 10 illustrated in FIG. 1. Specifically, FIG. 3 is a graph showing the difference (referred to as an “operation voltage” hereinafter) between the first power source voltage ELVDD and the second power source voltage ELVSS applied to the display region 10, and a characteristic curve of current flowing across the entire display.

In the graph of FIG. 3, a leftward direction on the horizontal axis is a direction in which the operation voltage increases, and an upward direction on the vertical axis is a direction in which a panel current increases.

The characteristic curve of FIG. 3 is divided into an area in which the panel current increases with a small slope as the operation voltage increases, and an area in which the panel current sharply increases as the operation voltage increases. The former area can be referred to as a saturation region, and the latter area can be referred to as a linear region. A boundary voltage between the two areas is referred to as a saturation point or voltage (Sat).

The current-voltage graph of the display region 10 as shown in FIG. 3 can be obtained by varying the voltage level of the second power source voltage ELVSS applied to the cathode electrode of the OLED within a certain range, where the voltage level of the first power source voltage ELVDD applied to the source electrode of the driving transistor M1 is fixed. Thus, an optimum or most efficient voltage at which the display region 10 is driven within the saturation region, at the saturation point Sat, can be obtained by varying the level of the second power source voltage ELVSS. With the saturation point Sat located, the second power source voltage ELVSS can be controlled, such that the operation voltage can be supplied at or approximate the level of the saturation point Sat, to compensate for a change in the driving voltage due to the changing or degrading characteristics from driving the display region 10.

That is, in the apparatus for supplying power according to an exemplary embodiment of the present invention, if the second power source voltage ELVSS supplied to the display region 10 is set to be a value at which the operation voltage is greater than a voltage at the saturation point Sat of the saturation region measured according to the characteristics of the display region 10 (e.g., a saturation voltage), then the display region 10 can be more stably driven in the saturation region, but power may be unnecessarily consumed to generate the second power source voltage ELVSS. Meanwhile, if the second power source voltage ELVSS is set to be a value at which the operation voltage is less than the voltage at the saturation point Sat (e.g., the saturation voltage), then the panel current of the display region 10 may not be able to represent a full white gray level.

Thus, in order to more stably implement the gray scale representation of the display region 10, while minimizing or reducing waste of power, the second power source voltage ELVSS should be supplied at a level where the operation voltage is at or approximate the saturation point Sat.

Thus, an apparatus for supplying power and a display device including the same according to an exemplary embodiment of the present invention are operated such that the saturation point Sat, which is an optimum or most efficient or desirable point of the saturation region, is measured by detecting the characteristics of the display region 10, and the second power source voltage ELVSS is modified and provided to the display region 10 for the display device to operate close to the saturation point Sat.

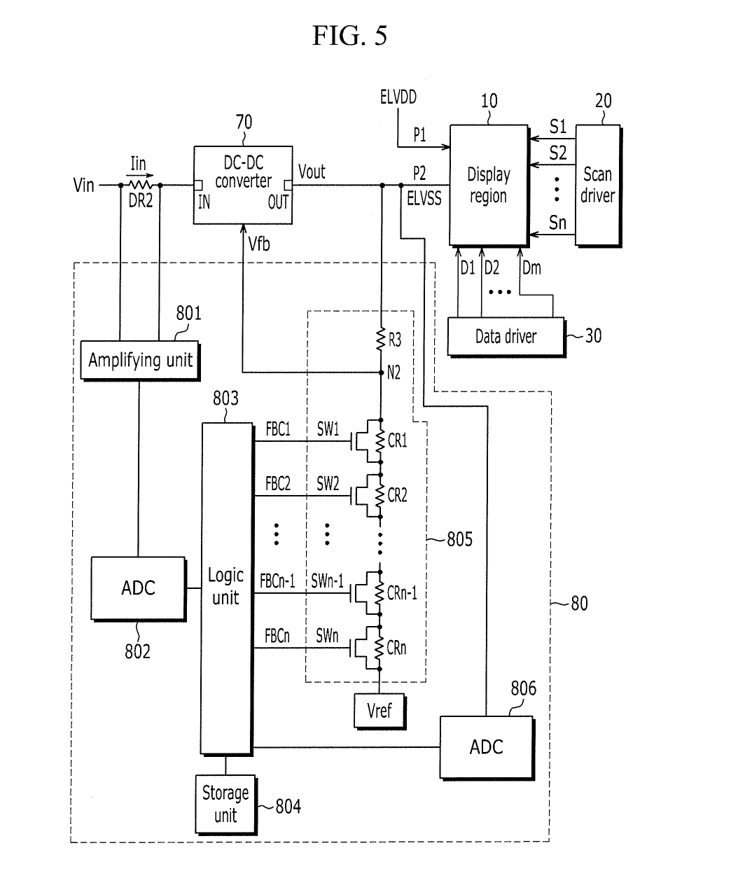

Apparatuses for supplying power according to respective exemplary embodiments of the present invention are illustrated in FIGS. 4 and 5.

FIGS. 4 and 5 are schematic block diagrams showing different apparatuses for supplying power according to two exemplary embodiments of the present invention. Specifically, FIGS. 4 and 5 are enlarged views of the apparatuses for supplying power in the block diagram of the display device of FIG. 1.

First, with reference to FIG. 4, an apparatus for supplying power according to an exemplary embodiment of the present invention transfers the second power source voltage ELVSS through the second power line P2 to the display region 10.

The apparatus for supplying power may include the DC-DC converter 50 and the power source voltage controller 60 connected to the second power line P2.

The DC-DC converter 50 generates the second power source voltage ELVSS upon receiving an input voltage Vin at an input terminal IN. Here, the second power source voltage ELVSS is changed according to the feedback voltage Vfb delivered after being generated by the power source voltage controller 60.

The power source voltage controller 60 includes a detection resistor DR1, an amplifying unit 601, an analog-to-digital converter (ADC) 602, a logic unit 603, a storage unit 604, a digital-to-analog converter (DAC) 605, an ADC 606, and a feedback voltage generating unit 607.

The DAC 605 may include a buffer.

The detection resistor DR1 is positioned on the input line delivering the input voltage Vin to the input terminal IN of the DC-DC converter 50, and because an input current Iin flowing along the input line flows across the detection resistor DR1, a voltage difference is generated across the detection resistor DR1.

The power source voltage controller 60 detects the input current Iin delivered to the input terminal of the DC-DC converter 50 by using the voltages at the ends of the detection resistor DR1. Hereinafter, the difference between the voltages at the ends of the detection resistor DR1 will be referred to as a “first detection voltage VS1”.

The amplifying unit 601 amplifies the first detection voltage VS1 and delivers the amplified first detection voltage VS1 (referred to as a “first amplified voltage AMV1” hereinafter) to the ADC 602. The ADC 602 outputs data corresponding to the input current Iin to the logic unit 603 according to the first amplified voltage AMV1. In the present exemplary embodiment, the input current Iin of the DC-DC converter 50 is used to measure the panel current. The input current Iin inputted to the DC-DC converter 50 and the panel current, an output current, have the same waveform, and the scale of the currents may be at a certain ratio. That is, information regarding the panel current can be obtained by multiplying the input current Iin by a certain ratio or multiple.

Meanwhile, an output voltage Vout outputted from an output terminal OUT of the DC-DC converter 50 is applied as the second power source voltage ELVSS to the display region 10 through the second power line P2, and in this case, the output voltage Vout is also detected and delivered to the ADC 606. The method for detecting the output voltage Vout is not particularly limited, and the output voltage Vout can be detected by using, for example, a detection resistor. According to the particular configuration, the output voltage Vout detected through the detection resistor may be transformed into a voltage that has been amplified by the amplifying unit, to be delivered to the ADC 606.

The ADC 606 generates data according to the output voltage Vout (referred to as “output voltage data” hereinafter), and outputs the same to the logic unit 603.

The power source voltage controller 60 of the apparatus for supplying power according to an exemplary embodiment of the present invention features the two ADCs 602 and 606 that respectively detect the input current Iin flowing along the input line and delivered to the input terminal IN of the DC-DC converter 50, and the output voltage Vout supplied to the second power line connected to the output terminal OUT of the DC-DC converter 50, generate corresponding current data and voltage data, and deliver the current data and the voltage data to the logic unit 603.

The logic unit 603 detects a certain saturation point Sat according to the received input current data and the output voltage data by using the current-voltage characteristic curve illustrated in FIG. 3.

The process of detecting the saturation point Sat may be performed by a certain feedback controller (not shown), and in this case, the feedback controller may be included in the logic unit 603.

The process of detecting the saturation point Sat through the feedback controller is not particularly limited. The variation, that is, the slope, of the output voltage data according to the input current data may be measured and a voltage corresponding to the output voltage data when the measured slope is, for example, greater than a certain threshold value may be detected as a saturation point Sat.

In addition, with reference to the current-voltage characteristic curve as shown in FIG. 3, as noted, the deviation of the slopes for adjacent or close coordinate values corresponding to the input current data and the output voltage data changes sharply at the saturation point Sat, so the saturation point Sat can be detected.

When the saturation point Sat is detected, the logic unit 603 controls a feedback signal such that the second power source voltage ELVSS applied to the display region 10 is at or approximately a voltage corresponding to the saturation point Sat. In detail, the voltage obtained by dividing the voltage outputted from the DAC 605 and the output voltage Vout by resistors R1 and R2 is the feedback voltage Vfb. Thus, the logic unit 603 outputs reference voltage data for controlling the feedback voltage Vfb such that the second power source voltage ELVSS becomes the voltage corresponding to the saturation point, that is, the voltage obtained by subtracting the voltage at the saturation point Sat from the first power source voltage ELVDD, and the DAC 605 outputs the voltage corresponding to the reference voltage data. Hereinafter, the voltage corresponding to the saturation point will be referred to as a “saturation voltage”.

Data information generated or received in this process may be stored in the storage unit 604. That is, the input current data and output voltage data delivered to the logic unit 603 or the reference voltage data and the like generated by the logic unit 603 may be stored in the storage unit 604, and the information stored in the storage unit 604 may be extracted to be used to generate the reference voltage data for controlling the power supply.

The DAC 605 outputs a reference voltage Vref to the feedback voltage generating unit 607 according to the reference voltage data delivered from the logic unit 603. According to an exemplary embodiment, a buffer (not shown) may be added, and in this case, the buffer may receive the reference voltage Vref from the DAC 605 and output the received reference voltage Vref to the feedback voltage generating unit 607.

The feedback voltage generating unit 607 may divide the voltage difference between the second power source voltage ELVSS and the reference voltage Vref corresponding to the resistors R1 and R2, and output the feedback voltage Vfb. Thus, when the reference voltage Vref is increased, the feedback voltage Vfb is increased, whereas when the reference voltage Vref is decreased, the feedback voltage Vfb is decreased. When the feedback voltage Vfb is decreased, the DC-DC converter 50 according to the present exemplary embodiment increases the second power source voltage ELVSS, and when the feedback voltage Vfb is increased, the DC-DC converter 50 decreases the second power source voltage ELVSS. Then, the second power source voltage ELVSS can be constantly maintained at or around the saturation voltage.

In detail, the feedback voltage generating unit 607 includes the resistors R1 and R2. The resistor R1 is connected between the output terminal OUT of the DC-DC converter 50 and a first node N1. The resistor R2 is connected between the first node N1 and the DAC 605.

In case of a configuration including a buffer, the buffer may be added between the resistor R2 and the DAC 605 to output the reference voltage Vref.

The apparatus for supplying power according to the present exemplary embodiment detects a voltage value corresponding to the saturation point Sat corresponding to the input current flowing to the DC-DC converter 50 and the output voltage Vout supplied as the second power source voltage ELVSS to the display region 10, and controls the feedback voltage Vfb, such that the second power source voltage ELVSS becomes the saturation voltage. The DC-DC converter 50 may output the second power source voltage ELVSS as the saturation voltage according to the controlled feedback voltage Vfb and supply the same to the display region 10. In this manner, in the present exemplary embodiment, the power source voltage may be supplied without a margin and unnecessary power consumption can be reduced.

FIG. 5 is a schematic block diagram showing an apparatus for supplying power according to another exemplary embodiment of the present invention.

With reference to FIG. 5, the apparatus for supplying power according to another exemplary embodiment of the present invention supplies the second power source voltage ELVSS to the display region 10 through the second power line P2.

The apparatus for supplying power illustrated in FIG. 5 includes a DC-DC converter 70 and a power source voltage controller 80. The display panel 10, the scan driver 20, and the data driver 30 are the same as those in the configuration illustrated in FIG. 1, so the same reference numerals are used and a detailed description thereof will be omitted.

The DC-DC converter 70 generates the second power source voltage ELVSS upon receiving the input voltage Vin at its input terminal IN. Here, a reference voltage Vref is fixed, while the second power source voltage ELVSS is changed according to the feedback voltage Vfb outputted from the power source voltage controller 80.

The power source voltage controller 80 includes a detection resistor DR2, an amplifying unit 801, an analog-to-digital converter (ADC) 802, a logic unit 803, a storage unit 804, a feedback controller 805, and an ADC 806.

The detection resistor DR2 is positioned on the input line delivering the input voltage Vin to the input terminal IN of the DC-DC converter 70, and because an input current in flowing along the input line flows across the detection resistor DR2, a voltage difference is generated across the detection resistor DR2.

The power source voltage controller 80 detects the input current Iin delivered to the input terminal of the DC-DC converter 70 by using the voltages at the ends of the detection resistor DR2. Hereinafter, the difference between the voltages at the ends of the detection resistor DR2 will be referred to as a “second detection voltage VS2”.

The amplifying unit 801 amplifies the second detection voltage VS2 and delivers the amplified second detection voltage VS2 (referred to as a “second amplified voltage AMV2” hereinafter) to the ADC 802. Then, the ADC 802 outputs data corresponding to the input current in to the logic unit 803 according to the second amplified voltage AMV2. In the present exemplary embodiment, the input current in of the DC-DC converter 70 is used to measure the panel current. The input current in inputted to the DC-DC converter 70 and the panel current, which is an output current, have the same waveform, and the scale of the currents may be at a certain ratio. That is, information regarding the panel current can be obtained by multiplying the input current in by a certain ratio or multiple.

Meanwhile, an output voltage Vout outputted from an output terminal OUT of the DC-DC converter 70 is applied as the second power source voltage ELVSS to the display region 10 through the second power line P2, and in this case, the output voltage Vout is also detected and delivered to the ADC 806. The method for detecting the output voltage Vout is not particularly limited, and the output voltage Vout can be detected by using, for example, a detection resistor. According to the particular configuration, the output voltage Vout detected through the detection resistor may be transformed into a voltage that has been amplified by the amplifying unit, to be delivered to the ADC 806.

The ADC 806 generates data according to the output voltage Vout (i.e., output voltage data), and outputs the same to the logic unit 803.

The logic unit 803 receives digital information obtained by sensing the input current and the output voltage of the DC-DC converter 70 through the two ADCs 802 and 806, respectively, provided in the power source voltage controller 80, and detects a certain saturation point Sat on such a current-voltage characteristic curve as illustrated in FIG. 3.

The process of detecting the saturation point Sat has been already described above with reference to FIG. 4, so a description thereof will be omitted.

When the saturation point Sat is detected, the logic unit 803 controls a feedback signal such that the second power source voltage ELVSS applied to the display region 10 is at or approximately a voltage corresponding to the saturation point Sat, and delivers the same to the DC-DC converter 70.

In detail, a voltage obtained by dividing a difference between the reference voltage Vref and the output voltage Vout by a resistor R3 and a plurality of resistors CR1˜CRn arranged in series is determined as the feedback voltage Vfb. In this case, the reference voltage may be received as a fixed voltage value from the DC-DC converter 70, but is not necessarily limited thereto.

In order to generate the feedback voltage Vfb, the logic unit 803 outputs a plurality of feedback voltage control signals FBC1˜FBCn to the feedback voltage generating unit 805 according to the input current data and the output voltage data.

The feedback voltage generating unit 805 adjusts the feedback voltage Vfb according to the plurality of feedback voltage control signals FBC1˜FBCn and delivers the same to the DC-DC converter 70.

The feedback voltage generating unit 805 may include a reference voltage applying unit Vref, the resistor R3, the plurality of resistors CR1˜CRn, and a plurality of switching elements SW1˜SWn. The resistor R3 is connected between the output terminal OUT of the DC-DC converter 70 and a second node N2. The plurality of resistors CR1˜CRn are connected in series between the second node N2 and the reference voltage applying unit Vref. If the reference voltage is received as a fixed voltage value from the DC-DC converter 70, the reference voltage applying unit Vref would be another output terminal of the DC-DC converter 70.

Meanwhile, each of the plurality of resistors CR1˜CRn includes a corresponding switching element connected between the ends of each of the resistors CR1˜CRn. Switching operations of the plurality of switching elements SW1˜SWn are controlled by a plurality of feedback voltage control signals FBC1˜FBCn. A resistance ratio between the resistor R3 and the plurality of resistors CR1˜CRn is adjusted according to ON/OFF operations of the plurality of switching elements SW1˜SWn, thus changing the potential of the second node N2, that is, the level of the feedback voltage Vfb. For example, when the switching element SW1 among the plurality of switching elements SW1˜SWn is turned on, ON resistance of the switching element SW1 is connected in parallel to the resistor CR1, in effect, bypassing resistor CR1. Accordingly, as the number of switching elements that are turned on among the plurality of switching elements SW1˜SWn increases, a total resistance value of the plurality of resistors CR1˜CRn is reduced. The reduction in the resistance value of the plurality of resistors CR1˜CRn resultantly causes the feedback voltage Vfb to be lowered to, for example, increase the second power source voltage ELVSS. Thus, the second power source voltage ELVSS to be outputted from the DC-DC converter 70 can be controlled to correspond to the saturation voltage and outputted, and accordingly, the power source voltage can be supplied to the display region 10 without a margin.

Meanwhile, in the present exemplary embodiment illustrated in FIG. 5, the plurality of switching elements SW1˜SWn are configured as NMOS transistors. Thus, when each of the plurality of feedback voltage control signals FBC1˜FBCn has a high voltage level, corresponding ones of the plurality of switching elements SW1˜SWn are turned on, and when the plurality of feedback voltage control signals FBC1˜FBCn has a low voltage level, the plurality of switching elements SW1˜SWn are turned off. However, the present invention is not limited thereto, and the plurality of switching elements SW1˜SWn may be configured as, for example, PMOS transistors.

In FIG. 5, detecting the input current and the output voltage of the DC-DC converter 70 and controlling the feedback voltage may be periodically performed automatically, and according to the particular configuration, a user may perform a certain control command to perform the corresponding operations.

The present invention has been described in relation to exemplary embodiments of the present invention, but they are merely illustrative, and the present invention is not limited thereto. The material of each element described in the disclosure of the present invention may be easily selected from various known materials and substituted by skilled persons in the art. Also, skilled persons in the art may omit a portion of the elements described in the disclosure of the present invention without degrading performance, or may add elements in order to improve the performance.

Therefore, while this invention has been described in connection with what is presently considered to be practical exemplary embodiments, it is to be understood that the invention is not limited to the disclosed embodiments, but is instead intended to cover various modifications and equivalent arrangements included within the spirit and scope of the appended claims.

What is claimed is:

1. An apparatus for supplying a power source voltage, the apparatus comprising:
a DC-DC converter for generating a power source voltage corresponding to an input voltage and a feedback voltage, and for supplying the power source voltage to a display region comprising a plurality of light emitting elements; and
a power source voltage controller for detecting an input current flowing to the DC-DC converter and the power source voltage outputted from the DC-DC converter, for generating the feedback voltage corresponding to the input current and the power source voltage, and for supplying the feedback voltage to the DC-DC converter.

2. The apparatus of claim 1, wherein the DC/DC converter is configured to receive the input voltage through an input line, and to deliver the power source voltage to each of the light emitting elements through a power line, and wherein the input current is detected by utilizing a detection resistor at the input line.

3. The apparatus of claim 1, wherein the power source voltage controller comprises:
a logic unit for detecting a saturation voltage value corresponding to a saturation point in a driving voltage range for driving the display region by utilizing variations in output voltage data corresponding to the power source voltage and in input current data corresponding to the input current, and for generating reference voltage data or a plurality of control signals for controlling the feedback voltage so that the power source voltage is adjusted to be a voltage corresponding to the saturation voltage value; and
a feedback voltage generating unit for generating the feedback voltage according to the reference voltage data or the plurality of control signals.

4. The apparatus of claim 3, wherein the power source voltage controller further comprises an amplifying unit for amplifying a voltage difference between the ends of the detection resistor, and for outputting the amplified voltage difference.

5. The apparatus of claim 3, wherein the power source voltage controller further comprises an analog-to-digital converter for generating the input current data from a detection voltage according to a voltage difference between the ends of the detection resistor, and for outputting the input current data to the logic unit.

6. The apparatus of claim 5, wherein the detection voltage is a voltage that has been amplified by an amplifying unit.

7. The apparatus of claim 3, wherein the power source voltage controller further comprises an analog-to-digital converter for generating the output voltage data corresponding to the power source voltage detected from a power line for delivering the power source voltage to the display region, and for outputting the generated output voltage data to the logic unit.

8. The apparatus of claim 3, wherein the feedback voltage generating unit comprises a first resistor unit and a second resistor unit connected in series between a power line for delivering the power source voltage to the plurality of light emitting elements and a reference voltage supplying unit for supplying a reference voltage, wherein the feedback voltage generating unit is configured to generate the feedback voltage by voltage dividing a voltage difference between the power source voltage and the reference voltage.

9. The apparatus of claim 8, wherein the feedback voltage is determined according to a resistance ratio of the first resistor unit and the second resistor unit.

10. The apparatus of claim 8, wherein the reference voltage supplying unit comprises a digital-to-analog converter for generating the reference voltage according to the reference voltage data generated by the logic unit.

11. The apparatus of claim 10, wherein the reference voltage supplying unit further comprises a buffer between the digital-to-analog converter and the first and second resistor units.

12. The apparatus of claim 8 wherein the reference voltage supplying unit comprises an output terminal of the DC-DC converter supplying the power source voltage.

13. The apparatus of claim 8 wherein the second resistor unit comprises:
a plurality of resistors connected in series between the first resistor unit and the reference voltage supplying unit; and
a plurality of switching elements respectively connected in parallel to the ends of corresponding ones of the resistors for performing a switching operation according to corresponding control signals from among a plurality of control signals that adjust a feedback voltage.

14. A display device comprising:
a display region comprising a plurality of light emitting elements configured to receive a first power source voltage and a second power source voltage having a lower voltage than the first power source voltage;
a DC-DC converter for generating the second power source voltage corresponding to an input voltage and a feedback voltage, and for supplying the second power source voltage to the plurality of light emitting elements; and
a power source voltage controller for detecting an input current flowing to the DC-DC converter and the second power source voltage outputted from the DC-DC converter, for generating the feedback voltage corresponding to the input current and the second power source voltage, and for supplying the feedback voltage to the DC-DC converter.

15. The device of claim 14, wherein the DC/DC converter is configured to receive the input voltage through an input line, and to deliver the second power source voltage to the light emitting elements through a power line, and wherein the input current is detected by utilizing a detection resistor at the input line.

16. The device of claim 14, wherein the power source voltage controller comprises:
a logic unit for detecting a saturation voltage value corresponding to a saturation point in a driving voltage range for driving the display region by utilizing variations in output voltage data corresponding to the second power source voltage and in input current data corresponding to the input current, and for generating reference voltage data or a plurality of control signals for controlling the feedback voltage so that the power source voltage is adjusted to be a voltage corresponding to the saturation voltage value; and
a feedback voltage generating unit for generating the feedback voltage according to the reference voltage data or the plurality of control signals.

17. The device of claim 16, wherein the power source voltage controller further comprises an analog-to-digital converter for generating the input current data from a detection voltage according to a voltage difference between the ends of the detection resistor, and for outputting the input current data to the logic unit.

18. The device of claim 16, wherein the power source voltage controller further comprises an analog-to-digital converter for generating the output voltage data corresponding to the second power source voltage detected from a power line for delivering the second power source voltage to the display region, and for outputting the generated output voltage data to the logic unit.

19. The device of claim 16, wherein the feedback voltage generating unit comprises a first resistor unit and a second resistor unit connected in series between a power line for delivering the second power source voltage to the plurality of the light emitting elements and a reference voltage supplying unit for supplying a reference voltage, wherein the feedback voltage generating unit is configured to generate the feedback voltage by voltage dividing a voltage difference between the second power source voltage and the reference voltage.

20. The device of claim 19, wherein the feedback voltage is determined according to a resistance ratio of the first resistor unit and the second resistor unit.

21. The device of claim 19, wherein the reference voltage supplying unit is configured to generate the reference voltage according to the reference voltage data generated by the logic unit.

22. The device of claim 19, wherein the reference voltage supplying unit comprises an output terminal of the DC-DC converter supplying the second power source voltage.

23. The device of claim 19, wherein the second resistor unit comprises:
a plurality of resistors connected in series between the first resistor unit and the reference voltage supplying unit; and
a plurality of switching elements respectively connected in parallel to the ends of corresponding ones of the resistors for performing a switching operation according to corresponding control signals from among a plurality of control signals that adjust a feedback voltage.

24. A method for driving a display device, the method comprising:
detecting an input current flowing to a DC-DC converter that generates a power source voltage and supplies the power source voltage to light emitting elements in a display region;
detecting the power source voltage outputted from the DC-DC converter;
generating a feedback voltage adjusted corresponding to the input current and the power source voltage; and
adjusting the power source voltage according to the feedback voltage and supplying the adjusted power source voltage to the light emitting elements.

25. The method of claim 24, wherein the detecting of the input current comprises:
measuring a voltage difference between the ends of a detection resistor at an input line that delivers the input current to the DC-DC converter;
amplifying the measured voltage difference; and
generating and supplying input current data corresponding to the amplified voltage difference.

26. The method of claim 24, wherein the detecting of the power source voltage comprises:
measuring the power source voltage from a power line that delivers the power source voltage from the DC-DC converter; and
generating and supplying output voltage data corresponding to the power source voltage.

27. The method of claim 24, wherein the generating of the feedback voltage comprises:
detecting a saturation voltage value corresponding to a saturation point in a driving voltage range for driving the display region by utilizing variations in output voltage data corresponding to the detected power source voltage and in the input current data corresponding to the detected input current;
generating reference voltage data or a plurality of control signals for controlling the feedback voltage so that the power source voltage is adjusted to be a voltage corresponding to the saturation voltage value; and
generating the feedback voltage according to the reference voltage data or the plurality of control signals.

28. The method of claim 27, wherein the generating of the feedback voltage further comprises:
generating a reference voltage according to the reference voltage data; and
voltage-dividing a voltage difference between the power source voltage and the reference voltage.

29. The method of claim 27, wherein, in the generating of the feedback voltage, the voltage difference between the power source voltage and the reference voltage is voltage-divided according to a resistance ratio between first and second resistor units connected in series, wherein the resistance ratio is adjusted by selectively connecting a plurality of resistors in the second resistor unit according to the plurality of control signals.
